(19) United States
(12) Patent Application Publication
(10) Pub. No.: US 2010/0265058 A1
(43) Pub. Date: Oct. 21, 2010

(54) RETRACTABLE EMERGENCY SIGNALING DEVICE ADAPTED FOR USE ON AN EMERGENCY RESPONSE VEHICLE

(76) Inventor: Alex Aretuo, Miami, FL (US)

Correspondence Address: RUBEN ALCOBA, ESQ., 3399 NW 72 AVENUE, SUITE211, MIAMI, FL, 33122, US

(21) Appl. No.: 12/427,022

(22) Filed: Apr. 21, 2009

(51) Int. Cl. B60Q 1/52

(52) U.S. Cl. 340/472

(57) ABSTRACT

A retractable emergency signaling device adapted for use on an emergency response vehicle comprising inter alia, an electric emergency indicator, a telescoping shaft assembly, a rotatable vehicle mounting bracket, and a selectively operable actuator mechanism comprising inter alia a cord member having at least one wire integrated therein. When the present invention is mounted on an emergency response vehicle, the driver of the emergency response vehicle will be able to selectively raise and lower an emergency indicator to a level that can be easily seen even from behind the largest SUV on the road today; thereby allowing an emergency response vehicle to be seen from a greater distance.

### BACKGROUND

The present device relates to emergency signaling devices, specifically, retractable emergency signaling device adapted for use on emergency response vehicles.

An emergency by definition implies the urgent need for assistance or relief, accordingly emergency response vehicles are the vehicles that respond to situations that require urgent need of assistance or relief.

Emergency response vehicles have been used by police departments, fire departments, and paramedics for several decades. Accordingly, the general public has grown accustomed to seeing and hearing various combinations of flashing lights and sirens associated with such emergency response vehicles.

The purpose of the flashing lights and sirens is to inform those on the road that an emergency response vehicle is approaching and that space must be created to allow the passage therefor.

As tautological as it may sound, in order to create space for the passage of something, one must know that the something is there. In a world of cellular phone earpieces and high wattage automobile stereo systems, it is possible that even a blearing siren can go unnoticed; a flashing light however, will not be ignored, provided it is seen.

While the general size and particularly the height of emergency response vehicles has remained substantially the same for the past several decades, the same is not true for civilian transportation vehicles. The increasingly large sport utility vehicle (SUV) and other four wheeled juggernauts that are now commonplace on the roadways have increased in size dramatically over the past several years and now are making it more and more difficult for the flashing lights of emergency vehicles to be seen.

The present invention was invented to address the foregoing problem. Specifically a retractable emergency signaling device adapted for use on emergency response vehicles comprising inter alia, an electric emergency indicator, a telescoping shaft assembly, a rotatable vehicle mounting bracket, and a selectively operable actuator mechanism comprising inter alia a cord member having at least one wire integrated therein.

When the present invention is mounted on an emergency response vehicle, the driver of the emergency response vehicle will be able to selectively raise and lower an emergency indicator to a level that can be easily seen even from behind the largest SUV on the road today; thereby allowing for emergency response vehicles to be seen from greater distance.

One of the key features of the present device is the integrated wiring in the cord member of the selectively operable actuator mechanism. By including said integrated wiring into the actuator mechanism, the cord member serves a dual purpose, i.e. it has a role in the extension and retraction of the telescoping shaft assembly and it serves as the power supply for the electric emergency indicator.

An objective of the present invention is to provide an emergency signaling device adapted for an emergency response vehicle that can be selectively raised to a pre-determined height.

Another objective of the present invention is to provide an emergency signaling device adapted for an emergency response vehicle that increases the visibility of the emergency response vehicle.

Another objective of the present invention is to provide an emergency signaling device adapted for an emergency response vehicle that can be stored in a retracted position when not in use.

Yet, a further objective of tie present invention is to provide an emergency signaling device adapted for an emergency response vehicle that can be adapted to a variety of emergency response vehicles.

U.S. Pat. No. 5,235,344 (hereinafter “the '344 patent”) discloses a drive control apparatus for an electrically-driven type extensible/retractable antenna. However, the '344 patent does not disclose an electric emergency signaling device.

For the foregoing reasons there exists a need for a retractable emergency signaling device adapted for use on emergency vehicles comprising inter alia, an electric emergency indicator, a telescoping shaft assembly, a rotatable vehicle mounting bracket, and a selectively operable actuator mechanism comprising inter alia a cord member having at least one wire integrated therein.

### SUMMARY

A retractable emergency signaling device adapted for use on emergency response vehicles comprising inter alia, an electric emergency indicator, a telescoping shaft assembly, a rotatable vehicle mounting bracket, and a selectively operable actuator mechanism comprising inter alia and a cord member having at least one wire integrated therein.

When the present invention is mounted on an emergency response vehicle, the driver of the emergency response vehicle will be able to selectively raise and lower an emergency indicator to a level that can be easily seen, even from behind the largest SUV on the road today, thereby allowing the emergency response vehicles to be seen from greater distances.

One of the key features of the present device is the integrated wiring in the cord member of the selectively operable actuator mechanism. By including said integrated wiring into the actuator mechanism, the cord member serves a dual purpose, i.e. it has a role in the extension and retraction of the telescoping shaft assembly and it serves as the power supply for the electric emergency indicator.

### DRAWINGS

These and other features, aspects, and advantages of the present invention will become better understood with regard to the following description, appended claims and drawings where:

FIG. 1, shows a partially cut away front plan view of one embodiment of the device;

FIG. 1a, shows a close up of a cut away front plan view of the cord member of one embodiment of the device;

FIG. 2, shows a perspective view of one embodiment of the mounting bracket adjustably coupled to a vehicle;

FIG. 3, shows a side elevation view of one embodiment of the electric emergency indicator of the device; and

FIG. 4, shows a shows a perspective view of one embodiment of the device mounted on a vehicle in an extended position.

### DESCRIPTION

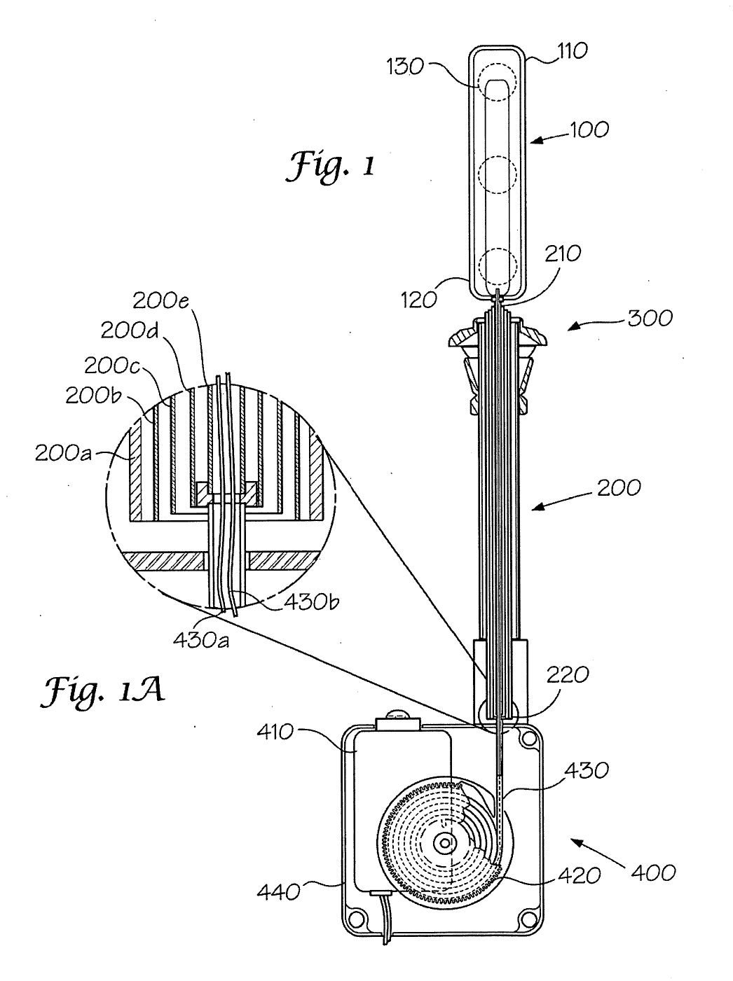

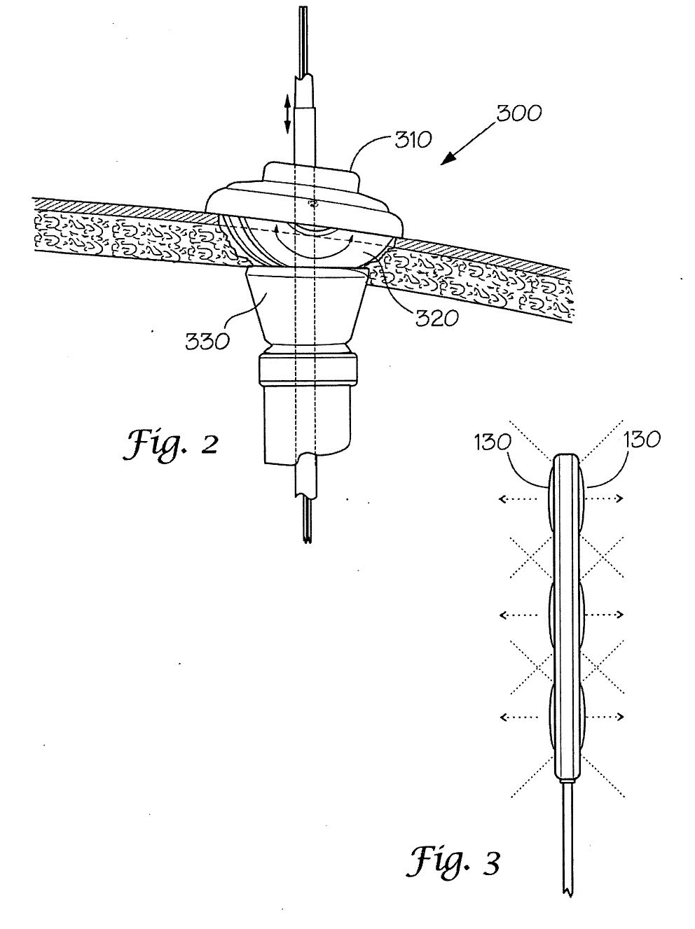

As shown in FIG. 1, a retractable emergency signaling device adapted for use on emergency response vehicles 10, the device 10, comprises an electric emergency indicator 100, a telescoping shaft assembly 200, a rotatable vehicle mounting bracket 300, and a selectively operable actuator mechanism 400.

The electric emergency indicator 100 has a top end 110 and a bottom end 120. It is envisioned that the electric indicator 100 might further include a plurality of light-emitting-diodes (LED) 130 whereby the LED 130 might be wired and configured to flash in a predetermined manner. It is further envisioned that the LED 130 might be sized, shaped, and colored differently according to the customs and standards of the emergency response vehicle to which the device 10 is mounted.

The telescoping shaft assembly 200 has a top end 210 and a bottom end 220, wherein the top end 210 of the telescoping shaft assembly 200 is fixedly attached to the bottom end 120 of the electric emergency indicator 100. The telescoping shaft assembly 200 comprises of a plurality of hollow members 200a-e, whereby each of the hollow members 200a-e is sized and configured to fit within one and other. It is envisioned that the telescoping shaft assembly 200 might be constructed of a metallic material such as aluminum or an aluminum composite material.

The rotatable vehicle mounting bracket 300 has a top cuff member 310, a curved mounting member 320, and a bottom cuff member 330. The rotatable vehicle mounting bracket 300 is adjustably coupled to the telescoping shaft assembly 200 at a location between the top end 210 and bottom end 220 of the telescoping shaft assembly 200. The curved mounting member 320 allows the device 10 to be mounted to the surface of a vehicle at various angles even when the surface of the vehicle is flat.

The selectively operable actuator mechanism 400 comprises of a motor means 410, a spool member 420, and a cord member 430 having at least one wire 430a and 430b integrated therein. The motor means 410 is sized and positioned in operative contact with the spool member 420 so that when the motor means 410 rotates the spool member 420 will rotate as well. The cord member 430 is attached to the spool member 420 so that when the spool member 420 rotates the cord member 430 either extends or retracts depending on the direction of rotation. The cord member 430 is fixedly attached and operatively connected to the first end 210 of the telescoping shaft assembly 200 so that when the cord member 430 extends or retracts, the telescoping shaft assembly 200 reacts in concert with the cord member 430. It is envisioned that the cord member 430 might have a semi rigid outer shell constructed out of a plastic or other suitable material to sustain the force needed to extend or retract the telescoping shaft assembly 200 as described herein. It is further envisioned that the actuator mechanism 400 might be contained in a housing 440 made of plastic or a composite material with similar properties.

It is envisioned that the actuator mechanism 400 might have selectively operable switch 450 operatively connected to the actuator mechanism 400, whereby said switch 450 might be located within the vehicle in which the device 10 is mounted. It is envisioned that the switch 450 might be configured so that the device 10 might be able to extend and retract to various heights depending on the need of the user of the device 10.

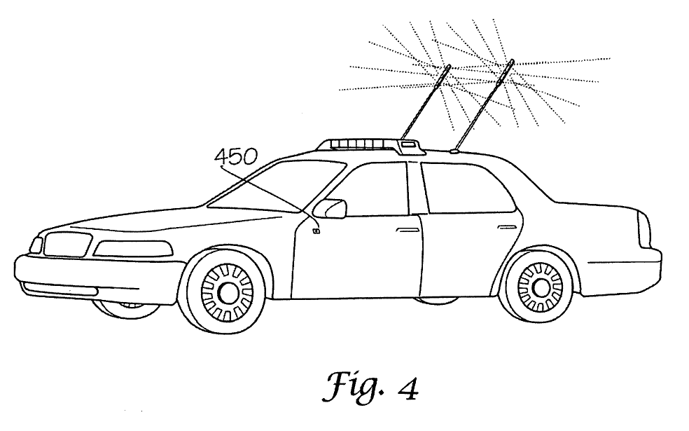

In operation, once the device 10 is mounted onto an emergency response vehicle (See FIG. 4), a user can activate the selectively operable actuator mechanism 400 from the inside of the emergency response vehicle using the selectively operable switch 450 and extend the electric emergency indicator 100 to a greater height, thereby alerting other vehicles on the roadway of the presence of the emergency response vehicle.

An advantage of the present invention is that it provides an emergency signaling device adapted for an emergency response vehicle that can be selectively raised to a pre-determined height.

Another advantage of the present invention is that it provides an emergency signaling device adapted for an emergency response vehicle that increases the visibility of the emergency response vehicle.

Yet a further advantage of the present invention is that it provides an emergency signaling device adapted for an emergency response vehicle that can be adapted to a variety of emergency response vehicles.

Although the present invention has been described in considerable detail with reference to certain preferred versions thereof, other versions are possible. Therefore, the spirit and the scope of the claims should not be limited to the description of the preferred versions contained herein.

What is claimed is:

1. A retractable emergency signaling device adapted for use on an emergency response vehicle comprising:
an electric emergency indicator having a top end and a bottom end;
a telescoping shaft assembly having a top end and a bottom end, wherein the top end of the telescoping shaft assembly is fixedly attached to the bottom end of the electric emergency indicator;
a rotatable vehicle mounting bracket, the rotatable vehicle mounting bracket is adjustably coupled to the telescoping shaft assembly at a location between the top end and bottom end of the telescoping shaft assembly; and
a selectively operable actuator mechanism, the actuator mechanism comprises a motor means for rotating a spool member, a spool member, and a cord member having at least one wire integrated therein, the actuator mechanism is operatively connected to telescoping shaft assembly.

2. The device of claim 1, further comprising of a selectively operable switch operatively connected to the actuator mechanism, whereby said switch is located within the vehicle in which the device is mounted.

3. The device of claim 2, wherein the electric emergency indicator further comprises at least one flashing indicator.

4. The device of claim 2, wherein the electric emergency indicator comprises of a plurality of light-emitting-diodes.

5. The device of claim 4, wherein the light-emitting-diodes vary in size.

6. The device of claim 5, wherein the light-emitting-diodes vary in color.
